(19) United States
(12) Patent Application Publication
(10) Pub. No.: US 2017/0223404 A1
(43) Pub. Date: Aug. 3, 2017

(54) DIGITAL TELEVISION AND SIGNAL PROCESSING APPARATUS THEREOF

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Wen ZHANG, Tianjin (CN); Song LIU, Tianjin (CN)

(21) Appl. No.: 15/250,564

(22) Filed: Aug. 29, 2016

Related U.S. Application Data
(63) Continuation of application No. PCT/CN2016/088484, filed on Jul. 4, 2016.

(30) Foreign Application Priority Data
Jan. 30, 2016 (CN) 201620099050.4

(51) Int. Cl. H04N 21/426; H04N 21/414

(52) U.S. Cl. CPC H04N 21/42607; H04N 21/414; H04N 21/4263

(57) ABSTRACT

A digital television and a signal processing apparatus thereof are disclosed. The digital television signal processing apparatus includes a control PCBA board and a digital demodulator standard module, wherein the digital demodulator standard module is detachably connected to the control PCBA board, the digital demodulator standard module is configured to demodulate a digital television intermediate frequency signal to obtain a digital transport stream signal, and the control PCBA board is at least configured to decode the digital transport stream signal. According to embodiments of the present disclosure, the digital demodulator standard module only needs to be replaced to accommodate different countries and regions, while maintaining the PCBA control board unchanged; in this way, the entire PCBA board doe not need to be changed, thereby reducing complexity in maintenance of a plurality of PCBA control boards, and promoting material universalization.

### CROSS-REFERENCE TO RELATED APPLICATIONS

This application is a continuation of International Application No. PCT/CN2016/088484 filed on Jul. 4, 2015, which is based upon and claims priority to Chinese Patent Application No. 2016200990504, filed before Chinese Patent Office on Jan. 30, 2016 and entitled “DIGITAL TELEVISION AND SIGNAL PROCESSING METHOD THEREOF”, the entire contents of which are incorporated herein by reference.

### TECHNICAL FIELD

Embodiments of the present disclosure relate to the technical field of digital televisions, and more particularly, to a digital television and a signal processing apparatus thereof.

### BACKGROUND

Television standards in various countries are different, and the differences mainly lie in the difference of frame rate (vertical scanning frequency), the difference of resolution, the difference of signal bandwidth and carrier frequency, the difference of the transformation relationship of color spaces and the like.

The television standard defines a method for transmitting television image signals and audio signals or other signals, a display format of the television images, and the technical standards employed by the method and television image display format. The televisions normally receive television signals and play television programs only when the same technical standards are observed. Black-and-white televisions have their television standards, for example, A, B, C, D, E, G, H, I, K, K1, L, M, N and the like, totally 13 standards (wherein A, C and E are no longer employed); color televisions have their television standards, for example, NTSC, PAL, SECAM and the like; and digital televisions have their specific standards, for example, DTMB, DVB-T/T2/C/C2, ATSC and ISDB.

During implementation of the present disclosure, the inventors have identified that the related art at least have the following technical problem: to accommodate different countries and regions, different digital television demodulators are needed; however, since in the related art the digital television demodulator is directly integrated on a printed circuit board+assembly (PCBA) board, different PCBA boards are needed with respect to different television standards in the market, and thus maintenance of a plurality of PCBA control boards is complicated and materials may not be universalized.

### SUMMARY

One of the objectives of the present disclosure is to provide a digital television and a signal processing apparatus thereof, to solve the technical problem in the related art that maintenance of a plurality of PCBA control boards is complicated and thus materials may not be universalized since different PCBA boards are needed to accommodate requirements in different countries and regions.

Technical solutions used in embodiments of the present disclosure are as follows:

Embodiments of the present disclosure provide a digital television signal processing apparatus, including a PCBA control board and a digital demodulator standard module, wherein the digital demodulator standard module is detachably connected to the PCBA control board, the digital demodulator standard module is configured to demodulate a digital television intermediate frequency signal to obtain a digital transport stream signal, and the PCBA control board is at least configured to decode the digital transport stream signal.

Embodiments of the present disclosure further provide a digital television, including the digital television signal processing apparatus as described above, wherein the digital television signal processing apparatus includes a PCBA control board and a digital demodulator standard module, wherein the digital demodulator standard module is detachably connected to the PCBA control board, the digital demodulator standard module is configured to demodulate a digital television intermediate frequency signal to obtain a digital transport stream signal, and the PCBA control board is at least configured to decode the digital transport stream signal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram illustrating a digital television signal processing apparatus according to some embodiments of the present disclosure;

FIG. 2 is a schematic structural diagram illustrating a digital television signal processing apparatus according to some embodiments of the present disclosure;

FIG. 3 is a schematic structural diagram illustrating a digital television signal processing apparatus according to some embodiments of the present disclosure;

FIG. 4 is a schematic structural diagram illustrating a digital television signal processing apparatus according to some embodiments of the present disclosure;

FIG. 5 is a schematic structural diagram illustrating a digital television signal processing apparatus according to some embodiments of the present disclosure;

FIG. 6 is a schematic structural diagram illustrating a digital television signal processing apparatus according to some embodiments of the present disclosure;

FIG. 7 is a schematic structural diagram illustrating a digital television signal processing apparatus according to some embodiments of the present disclosure;

FIG. 8 is a schematic structural diagram illustrating a digital television signal processing apparatus according to some embodiments of the present disclosure;

FIG. 9 is a schematic structural diagram illustrating a digital television signal processing apparatus according to some embodiments of the present disclosure;

FIG. 10 is a schematic structural diagram illustrating a digital television signal processing apparatus according to some embodiments of the present disclosure;

FIG. 11 is a schematic structural diagram illustrating a digital television signal processing apparatus according to some embodiments of the present disclosure;

FIG. 12 is a schematic structural diagram illustrating a digital television signal processing apparatus according to some embodiments of the present disclosure;

FIG. 13 is a schematic structural diagram illustrating a digital television signal processing apparatus according to some embodiments of the present disclosure; and

FIG. 14 is a schematic structural diagram illustrating a digital television signal processing apparatus according to some embodiments of the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

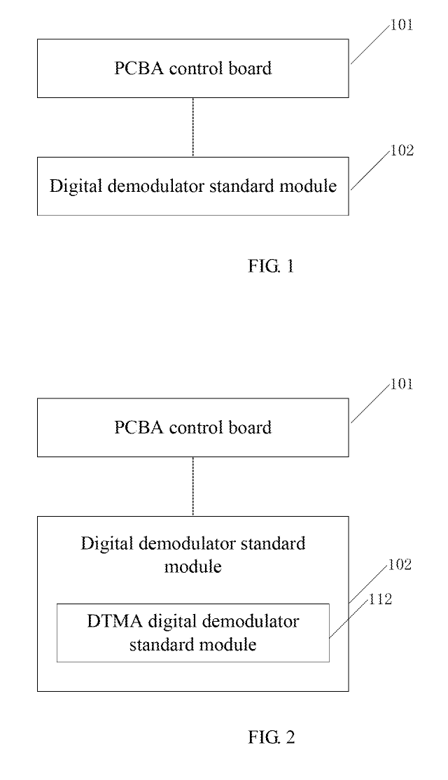

FIG. 1 is a schematic structural diagram illustrating a digital television signal processing apparatus according to some embodiments of the present disclosure. As illustrated in FIG. 1, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the structure related to digital demodulation in the related is separated from the PCBA control board 101, and the structure is detachably connected to the PCBA control board 101. To match with the demodulation manner in a specific country or region, the corresponding digital modulator standard module 102 only needs to be replaced. In addition, since the PCBA control board has no structure related to digital demodulation, no modification, such as modifications on hardware, needs to be made to the PCBA control board. Therefore, a PCBA control board 101 is applicable to digital demodulators supporting different standards.

However, it should be noted that although this embodiment schematically illustrates that the PCBA control board is applicable to digital televisions, persons of ordinary skill in the art would readily envisage that the PCBA control board is also applicable to traditional black-and-white televisions and color televisions, which is not described herein any further.

FIG. 2 is a schematic structural diagram illustrating a digital television signal processing apparatus according to some embodiments of the present disclosure. As illustrated in FIG. 2, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the digital demodulator standard module 102 includes a DTMB digital demodulator standard module 112.

DTMB is an acronym of digital television terrestrial multimedia broadcasting, which defines frame structure, channel coding and demodulation of a digital television terrestrial broadcasting system. According to the digital television terrestrial broadcasting service requirements, transmission conditions and channel characteristics, a national standard-compliant DTMB transmission system employs an innovative time-domain synchronous orthogonal frequency-division multiplexing (TDS-OFDM) single-carrier demodulation standard. This demodulation standard is designed mainly directed to the linear time-varying broadband transmission channel characteristics (transmission channel featuring both frequency-domain selectivity and time-domain selectivity) of the digital television terrestrial broadcasting channel.

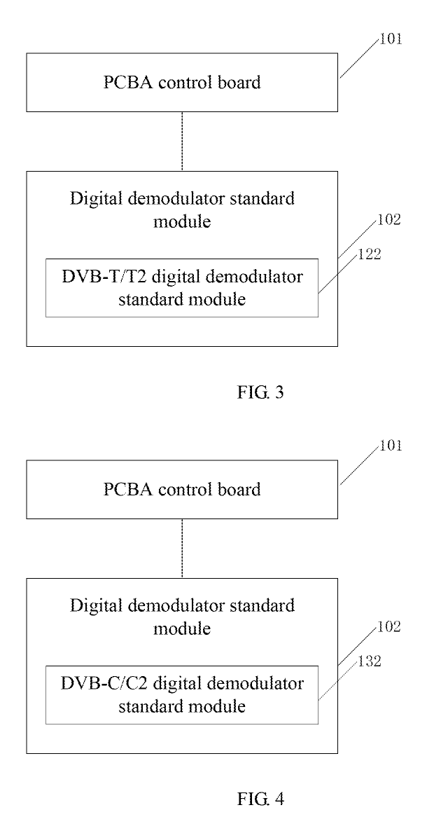

FIG. 3 is a schematic structural diagram illustrating a digital television signal processing apparatus according to some embodiments of the present disclosure. As illustrated in FIG. 3, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the digital demodulator standard module 102 includes a DVB-T/T2 digital demodulator standard module 122, wherein the former is the first generation demodulator standard module and the latter is the second generation demodulator standard module, and a common technical concept of these two generations is the CP-OFDM technology, frequency-domain pilot technology and QAO modulation technology.

The Digital Video Broadcasting-Second Generation Terrestrial (DVB-T2) is the second generation of European digital television terrestrial broadcasting transmission standard, which is referred to T2 hereinafter. With a spectrum bandwidth of 8 MHz, a supported maximum TS stream transmission rate is 50.1 Mbit/s (if the empty packets that may be removed are included, the maximum TS stream transmission rate may reach 100 Mbit/s).

FIG. 4 is a schematic structural diagram illustrating a digital television signal processing apparatus according to some embodiments of the present disclosure. As illustrated in FIG. 4, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the digital demodulator standard module 102 includes a DVB-C/C2 digital demodulator standard module 132, wherein the former is the first generation demodulator standard module and the second is the second generation demodulator module.

The digital video broadcasting-cable/cable 2 (DVB-C-C2) employs a modulation standard in which the bandwidth is narrow, the frequency utilization rate is high and the interference-resistant capability is strong. In addition, since the channel signal-to-noise ratio is high and the bit error ratio is low, lower requirements are imposed on error correction capabilities. Therefore, in the DVB-C, the channel portion employs an RS code and convolution code interleaving technology and quadrature amplitude modulation (QAM). The DVB-C may include, in terms of hardware, a modulator, a channel distributor, a cabled television network and the like.

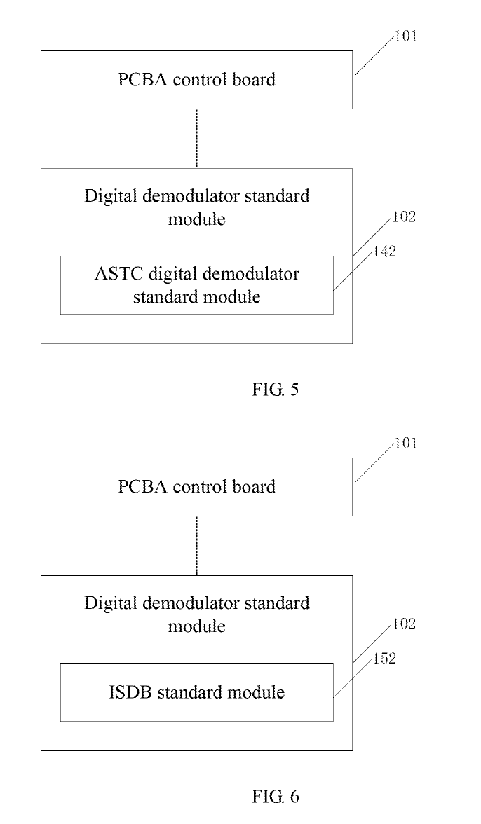

FIG. 5 is a schematic structural diagram illustrating a digital television signal processing apparatus according to some embodiments of the present disclosure. As illustrated in FIG. 5, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the digital demodulator standard module 102 includes an ATSC digital modulator standard module 142.

ATSC is a digital television national standard of the United States, and is an acronym of Advanced Television Systems committee. In the ATSC, signal source coding employs MPEG-2 video compression and AC-3 audio compression, and channel coding employs VSD modulation, and provides two standards: terrestrial broadcasting standard (8 VSB) and high data rate standard (16 VSB).

FIG. 6 is a schematic structural diagram illustrating a digital television signal processing apparatus according to some embodiments of the present disclosure. As illustrated in FIG. 6, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the digital demodulator standard module 102 includes an ISDB digital modulator standard module 152.

Integrated services digital broadcasting-terrestrial (ISDB) is mainly applicable to digital televisions in Japan, which is similar to the DVB in Europe, and still employs the transmission solution of COFDM and uses the same coding standard modulation standard, supporting two standards: 2K and 8K. Since the television in Japan has a radio frequency bandwidth of 6 MHz, the number of carriers and interval of carriers are different. The ISDB has the characteristics of flexibility, extensibility and universality and the like, and thus may flexibly integrated with and send multi-program television and other data services.

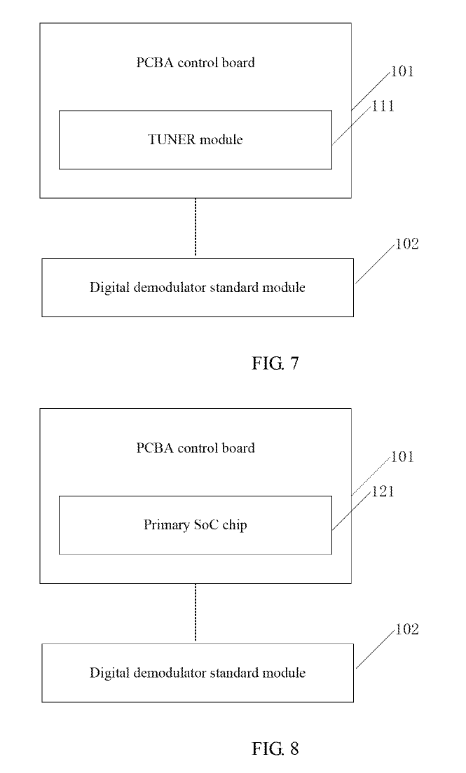

FIG. 7 is a schematic structural diagram illustrating a digital television signal processing apparatus according to some embodiments of the present disclosure. As illustrated in FIG. 7, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the PCBA control board 101 includes a TUNER module 111, wherein the TUNER module is configured to receive an RF signal and filter the RF signal to generate a digital television intermediate frequency signal. The TUNER module may be formed of a TUNER, a CPU and backhaul (optionally).

The digital demodulator standard module 102 may include any one or more of the standard modules as illustrated in FIG. 2 to FIG. 6.

FIG. 8 is a schematic structural diagram illustrating a digital television signal processing apparatus according to some embodiments of the present disclosure. As illustrated in FIG. 8, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

Specifically, in some embodiments of the present disclosure, the PCBA control board 101 includes a primary SoC chip 121, wherein the primary SoC chip is configured to decode the digital transport stream signal.

The digital demodulator standard module 102 may include any one or more of the standard modules as illustrated in FIG. 2 to FIG. 6.

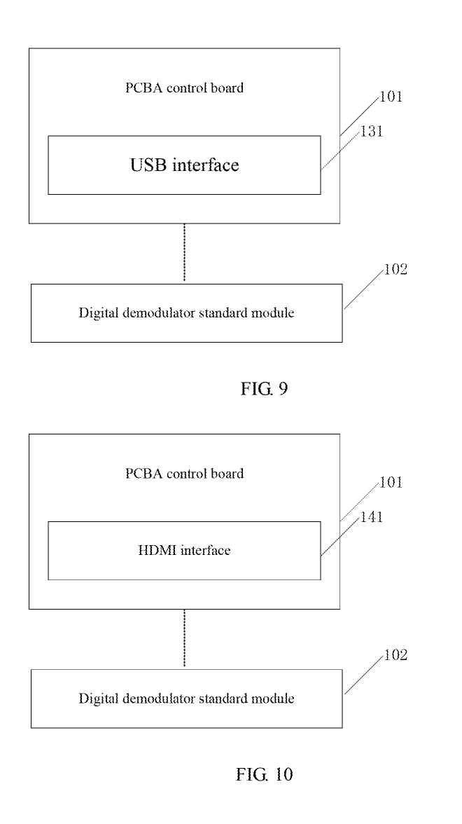

FIG. 9 is a schematic structural diagram illustrating a digital television signal processing apparatus according to some embodiments of the present disclosure. As illustrated in FIG. 9, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

Specifically, in some embodiments of the present disclosure, the PCBA control board 101 includes a USB interface 131, configured to transmit a USB format digital television signal.

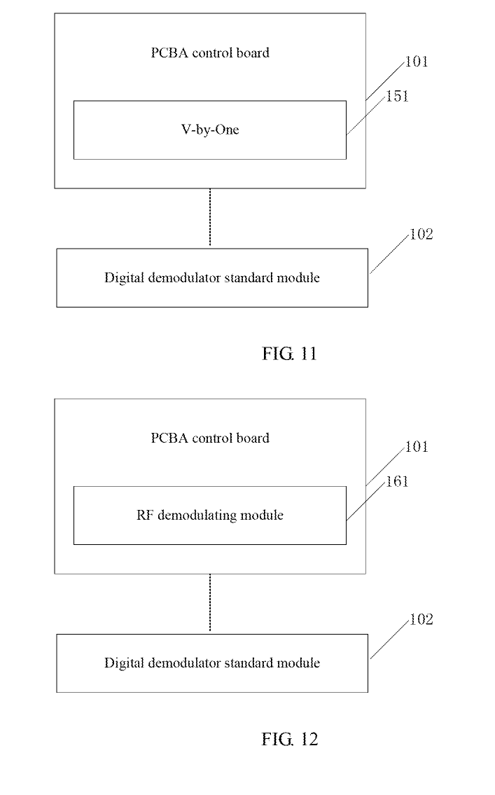

FIG. 10 is a schematic structural diagram illustrating a digital television signal processing apparatus according to some embodiments of the present disclosure. As illustrated in FIG. 10, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

Specifically, in some embodiments of the present disclosure, the PCBA control board 101 includes an HDMI interface 141, configured to transmit an image signal in an HDMI format digital television signal.

A high definition multimedia interface (HDMI) is a digital video/audio interface technology, and is a dedicated digital interface suitable for image transmission. The HDMI is capable of transferring both audio signals and image signals, with a maximum data transmission rate of 4.5 GB/s, and before signal transmission, no digital-to-analog conversion or analog-to-digital conversion is needed.

FIG. 11 is a schematic structural diagram illustrating a digital television signal processing apparatus according to some embodiments of the present disclosure. As illustrated in FIG. 11, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

Specifically, in some embodiments of the present disclosure, the PCBA control board 101 includes a V-by-One interface 131, configured to transmit a V-by-One format digital television signal.

V-by-One is a digital interface standard developed for image transmission. Specifically, input and output of V-by-One signals employ Low Voltage Differential Signaling (LDVS). The board card has a signal frequency of 1 GHz. Compared with the CMOS/TTL, V-by-One may reduce the number of transmission cables to 1/10 of the conventional number of transmission cables. In addition, the IC of V-by-One supports two forward channels, and supports a maximum definition of 4K×2K, an update frequency of 240 Hz, and 12 bits of each color (32 channels more than those on the IC are used). Particularly, V-by-One also supports various 3D video signals and a high-quality resolution matchable with the cinema, for example, video signal transmission at the aspect ratio is 21:9, and the pixels of 2560×1080.

FIG. 12 is a schematic structural diagram illustrating a digital television signal processing apparatus according to some embodiments of the present disclosure. As illustrated in FIG. 12, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

Specifically, in some embodiments of the present disclosure, the PCBA control board 101 includes an RF demodulating module 161, configured to receive an RF signal.

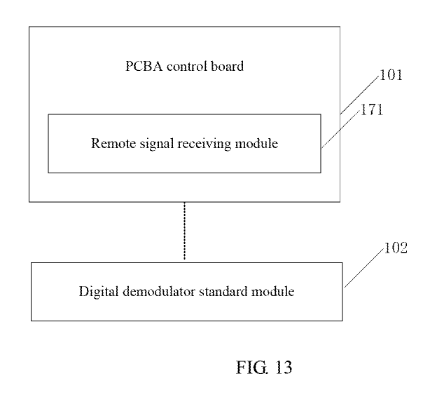

FIG. 13 is a schematic structural diagram illustrating a digital television signal processing apparatus according to some embodiments of the present disclosure. As illustrated in FIG. 13, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

Specifically, in some embodiments of the present disclosure, the PCBA control board 101 includes a remote control signal receiving module 171, configured to receive a remove control signal.

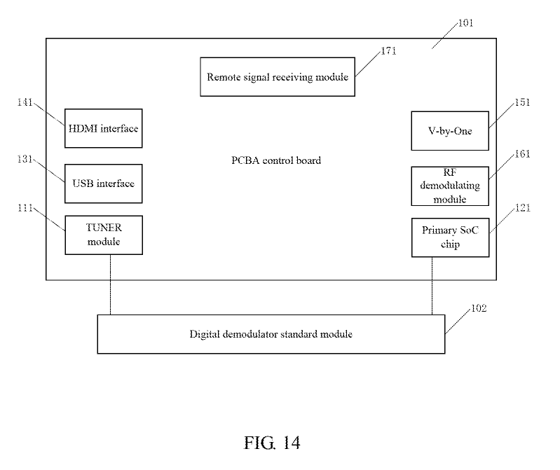

FIG. 14 is a schematic structural diagram illustrating a digital television signal processing apparatus according to some embodiments of the present disclosure. As illustrated in FIG. 14, the digital television signal processing apparatus may include a PCBA control board 101 and a digital demodulator standard module 102, wherein the digital demodulator standard module 102 is detachably connected to the PCBA control board 101, the digital demodulator standard module 102 is configured to demodulate a digital television intermediate frequency signal to obtain a digital transport stream signal, and the PCBA control board 101 is at least configured to decode the digital transport stream signal.

In this embodiment, the PCBA control board 101 includes:
a TUNER module 11, wherein the TUNER module is configured to generate the digital television intermediate frequency signal;
a primary SoC chip 121, wherein the primary SoC chip is configured to decode the digital transport stream signal;
a USB interface 131, configured to transmit a USB format digital television signal;
an HDMI interface 141, configured to transmit a HDMI format digital television signal;
a V-by-One interface 151, configured to transmit a V-by-One format image signal;
an RF demodulation module 161, configured to receive a radio frequency signal; and
a remote control signal receiving module 171, configured to receive a remote control signal.

It should be noted that the components included in the PCBA control board 101 may be flexibly configured according to the actual needs. For example, any one of the structural units as illustrated in FIG. 7 to FIG. 13 may be only included, or any two or more of the structural units may be included.

Some embodiments of the present disclosure further provides a digital television, which includes the digital television signal processing apparatus disclosed in any one of the above embodiments. Details are thus not given herein any further.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part or all of the modules may be selected according to the actual needs to achieve the objectives of the technical solutions of the embodiments. Persons of ordinary skill in the art may understand and implement the present disclosure without paying any creative effort.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A digital television signal processing apparatus, comprising a PCBA control board and a digital demodulator standard module, wherein the digital demodulator standard module is detachably connected to the PCBA control board, the digital demodulator standard module is configured to demodulate a digital television intermediate frequency signal to obtain a digital transport stream signal, and the PCBA control board is at least configured to decode the digital transport stream signal.

2. The apparatus according to claim 1, wherein the digital demodulator standard module is a DTMB or DVB-T/T2 or DVB-C/C2 or ATSC or ISDB digital demodulator standard module.

3. The apparatus according to claim 1, wherein the PCBA control board comprises a TUNER module, wherein the TUNER module is configured to generate the digital television intermediate frequency signal.

4. The apparatus according to claim 1, wherein the PCBA control board comprises a primary SoC chip, wherein the primary SoC chip is configured to decode the digital transport stream signal.

5. The apparatus according to claim 1, wherein the PCBA control board comprises a USB interface, configured to transmit a USB format digital television signal.

6. The apparatus according to claim 1, wherein the PCBA control board comprises an HDMI interface, configured to transmit a HDMI format digital television signal.

7. The apparatus according to claim 1, wherein the PCBA control board comprises a V-by-One interface, configured to transmit a V-by-One format image signal.

8. The apparatus according to claim 1, wherein the PCBA control board comprises an RF demodulation module, configured to receive a radio frequency signal.

9. The apparatus according to claim 1, wherein the PCBA control board comprises a remote control signal receiving module, configured to receive a remote control signal.

10. A digital television, comprising the digital television signal processing apparatus as defined in claim 1, wherein the digital television signal processing apparatus comprises a PCBA control board and a digital demodulator standard module, wherein the digital demodulator standard module is detachably connected to the PCBA control board, the digital demodulator standard module is configured to demodulate a digital television intermediate frequency signal to obtain a digital transport stream signal, and the PCBA control board is at least configured to decode the digital transport stream signal.

11. The apparatus according to claim 10, wherein the digital demodulator standard module is a DTMB or DVB-T/T2 or DVB-C/C2 or ATSC or ISDB digital demodulator standard module.

12. The apparatus according to claim 10, wherein the PCBA control board comprises a TUNER module, wherein the TUNER module is configured to generate the digital television intermediate frequency signal

13. The apparatus according to claim 10, wherein the PCBA control board comprises a primary SoC chip, wherein the primary SoC chip is configured to decode the digital transport stream signal.

14. The apparatus according to claim 10, wherein the PCBA control board comprises a USB interface, configured to transmit a USB format digital television signal.

15. The apparatus according to claim 10, wherein the PCBA control board comprises an HDMI interface, configured to transmit a HDMI format digital television signal.

16. The apparatus according to claim 10, wherein the PCBA control board comprises a V-by-One interface, configured to transmit a V-by-One format image signal.

17. The apparatus according to claim 10, wherein the PCBA control board comprises an RF demodulation module, configured to receive a radio frequency signal.

18. The apparatus according to claim 10, wherein the PCBA control board comprises a remote control signal receiving module, configured to receive a remote control signal.
